(19) United States
(12) Patent Application Publication
(10) Pub. No.: US 2011/0134919 A1
(43) Pub. Date: Jun. 9, 2011

(54) METHOD AND SYSTEM FOR SELECTABLE RELIABLE MULTICAST DELIVERY OF DATA USING A PRESENCE SERVICE

(75) Inventor: ROD N. AVERBUCH, CHICAGO, IL (US)

(73) Assignee: MOTOROLA, INC., SCHAUMBURG, IL (US)

(21) Appl. No.: 12/631,279

(22) Filed: Dec. 4, 2009

(51) Int. Cl. H04L 12/56

(52) U.S. Cl. 370/392

(57) ABSTRACT

A mechanism for selectable reliable multicast delivery of data, such as presence information or other media, to communication devices is implemented in a communication system. A multicast group includes a plurality of communication devices, wherein a subset of the plurality of communication devices sends a subscription for reliable multicast delivery of data to a presence server using a presence service. For those devices in the subset having a confirmed mode of multicast delivery enabled, the data is sent using the confirmed mode of multicast delivery, wherein an acknowledgement is required upon receipt of the data. For all remaining devices in the multicast group, the data is sent using an unconfirmed mode of multicast delivery, wherein no such acknowledgement is required.

### FIELD OF THE DISCLOSURE

The present disclosure relates generally to delivering data to communication devices and more particularly to selectable reliable multicast delivery of data to communication devices using a presence service.

### BACKGROUND

Providing data for a large group of communication devices can cause a spike of load on a communication network. For example, delivering presence information during a shift change or delivering presence information and other media during incident assignments can create a heavy downlink load from servers to communication devices in a wireless network when unicast delivery methods are used. Using an unreliable multicast mechanism decreases the downlink load. However, there are instances when a reliable transport means may still need to be used to delivery data to some members of a multicast group. Current multicast mechanisms provide for all reliable multicast delivery of data, which requires acknowledgement of receipt of the data from all members of the multicast group. This then floods the network with acknowledgements, thereby minimizing the effectiveness of the multicast mechanism in conserving network resources.

Accordingly, what is needed is a mechanism for selectable reliable multicast delivery of data to communication devices in a communication system.

### BRIEF DESCRIPTION OF THE FIGURES

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a block diagram of a communication system for selectable reliable multicast delivery of data in accordance with some embodiments.

FIG. 2 is a signaling diagram illustrating signaling between devices to implement the selectable reliable multicast delivery of data in accordance with some embodiments.

FIG. 3 is a signaling diagram illustrating signaling between devices to implement the selectable reliable multicast delivery of data in accordance with some embodiments.

FIG. 4 is a signaling diagram illustrating signaling between devices to implement the selectable reliable multicast delivery of data in accordance with some embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Generally speaking, pursuant to the various embodiments, a mechanism for selectable reliable multicast delivery of data, such as presence information or other media, to devices is implemented in a communication system. A multicast group includes a plurality of devices, wherein a subset of the plurality of devices sends a subscription for reliable multicast delivery of data to a presence server using a presence service. For those devices in the subset having a confirmed mode of multicast delivery enabled, the data is sent using the confirmed mode of multicast delivery, wherein an acknowledgement is required upon receipt of the data. For all remaining devices in the multicast group, the data is sent using an unconfirmed mode of multicast delivery, wherein no such acknowledgement is required.

Using such a mechanism, multicast delivery of data to a group of devices can be used to conserve communication resources while still allowing reliable delivery of the data to select members of the multicast group. Those skilled in the art will realize that the above recognized advantages and other advantages described herein are merely illustrative and are not meant to be a complete rendering of all of the advantages of the various embodiments.

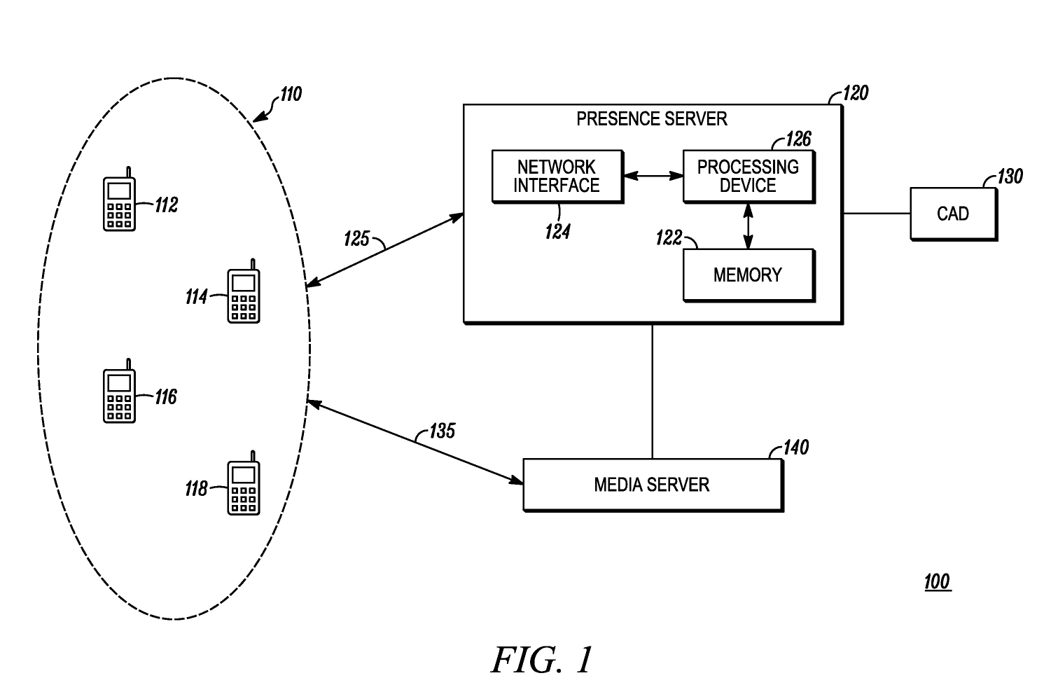

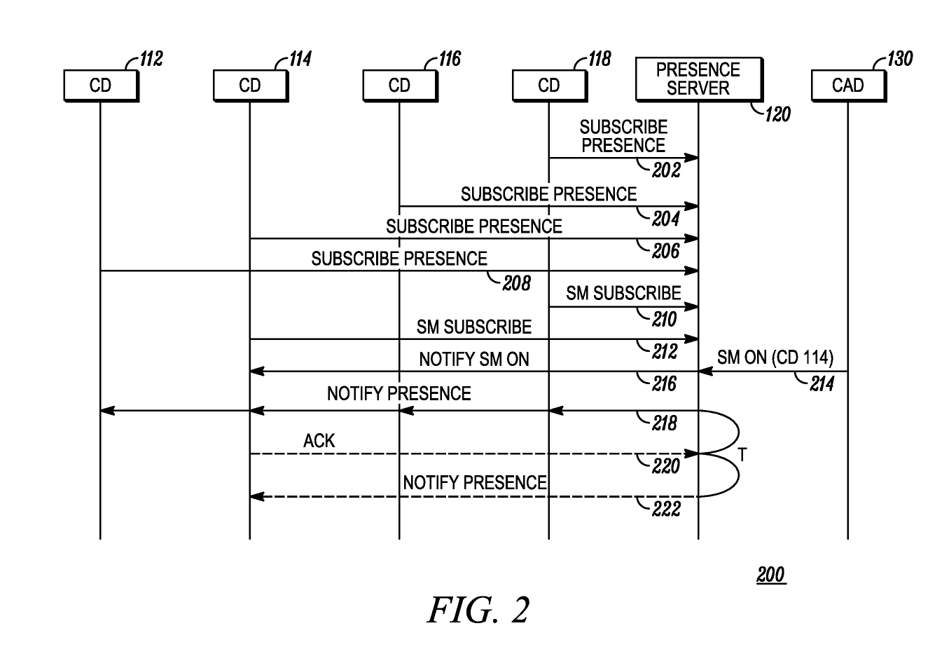

Referring now to the drawings, and in particular FIG. 1, a block diagram illustrating a communication system is shown and indicated at 100, which implements selectable reliable multicast delivery of data in accordance with embodiments of the present disclosure. Those skilled in the art will recognize and appreciate that the specifics of the examples in this detailed description are merely illustrative of some embodiments and that the teachings set forth herein are applicable in a variety of alternative settings. For example, in the described embodiments, the presence service that is implemented in the communications system 100 is performed using proprietary protocols (such as protocols that implement the embodiments of the disclosure described by reference to FIGS. 2 to 4) and standard protocols, such as the Presence SIMPLE Specification (current draft dated Feb. 3, 2009) published by Open Mobile Alliance (OMA) that defines an application level specification for a SIP/SIMPLE-based presence service that makes use of SIP (Session Initiation Protocol described in RFC 3261); and SIMPLE made simple (current draft dated Mar. 9, 2009) published by the Internet Engineering Task Force (IETF) that describes instant messaging and presence using SIP, wherein the standard presence protocols are collectively referred to herein as SIP/SIMPLE. However, the described teachings are in no way limited to this system implementation. Moreover, the system may include more watchers, presentities, presence servers, communication devices, media servers, CAD systems, and other entities than what is shown in FIG. 1.

The communications system 100 comprises: a multicast group 110 comprising communication devices 112, 114, 116, and 118, a presence server 120, a remote network entity 130, which in this case is a CAD (computer aided dispatch) system, and a media server 140. These elements are all communicatively coupled over one or more networks (not shown) for selectable reliable multicast delivery of data to the communication devices, in accordance with the teachings herein. The one or more networks can be a wired network, a wireless network, or a network enabling both wired and wireless communications and usually includes a number of network infrastructure devices including, but not limited to, bridges, switches, zone controllers, base station controllers, repeaters, base radios, base stations, base transceiver stations, access points, routers or any other type of infrastructure equipment interfacing any entity in a wireless or wired environment. For example, in one illustrative implementation, the presence server 120, CAD system 130, and media server 140 communicate using a wired network; and the presence server and media server communicate with the multicast group 110 over a wireless network.

The elements of system 100 will now be individually described. Turning first to the multicast group 110 of communication devices; as the term is used herein, multicast or multicast delivery is the simultaneous delivery of data to multiple devices that have joined a multicast group. Multicast includes such mechanisms as IP (internet protocol) multicast, wherein each device interested in receiving data via multicast delivery uses known signaling techniques (e.g., using a JOIN message sequence) to join a multicast IP address to receive the data. Accordingly, in this illustrative embodiment, communication devices 112, 114, 116, 118 have used any suitable means, such as joining a multicast address to become a member of the multicast group 110.

The multicast groups can be statically configured or dynamically determined, for example by the presence server or the media server determining groups of devices requesting the same information. Upon generating one or more multicast groups, the presence server or multicast server might broadcast the corresponding multicast address to all communication devices in the network; or may send unicast messages to those communication devices that should join particular multicast groups; or may use any other suitable means to publish the multicast addresses. Also, even though not illustrated, the multicast group can include certain infrastructure devices, such as servers, that may have a need for the information distributed within the multicast group and that may have a need for reliable multicast delivery of data as described below.

The communication devices 112, 114, 116, and 118 are also referred to in the art as client entities, access devices, access terminals, user equipment, mobile stations, mobile subscriber units, mobile devices, and the like, and can be any standard communication device such as radios, mobile phones, Personal Digital Assistants (PDAs), laptops, two-way radios, cell phones, and any other device capable of operating in a wired or wireless environment. Each communication device includes (although not shown) a memory, one or more network interfaces, and a processing device that are operatively coupled, and which when programmed form the means for the communication devices to implement their desired functionality.

The network interfaces can be used for, one or more of: publishing presence information for a presentity to the presence server 120; joining the multicast group 110; subscribing to presence information for a presentity and, as a result of the subscribing, receiving notifications from the presence server 120; publishing presence information to the presence server for a presentity; subscribing to the presence server for selectable reliable multicast delivery of data, in accordance with the teachings herein; requesting and receiving media from the media server; and any other communications with the presence server 120 or media server 140 to enable the implementation of methods in accordance with the present teachings. The implementation of the network interfaces in the communication devices depends on the particular type of network, i.e., wired and/or wireless, to which the communication devices are connected. For example, where the network supports wired communications, the interfaces may comprise a serial port interface (e.g., compliant to the RS-232 standard), a parallel port interface, an Ethernet interface, a USB interface, and/or a FireWire interface, and the like. Where the network supports wireless communications, the interfaces comprise elements including processing, modulating, and transceiver elements that are operable in accordance with any one or more standard or proprietary wireless interfaces, wherein some of the functionality of the processing, modulating, and transceiver elements may be performed by means of the processing device of the communication device through programmed logic such as software applications or firmware stored on the memory device of the communication device.

Besides the above-mentioned functionality, implemented via programmed logic or code, the processing device of each communication device is further programmed with logic or code for performing signaling such as that included in signaling diagrams illustrated in FIGS. 2 to 4; and/or the processing device may be implemented as a state machine or ASIC. The memory in the communication devices can include short-term and/or long-term storage of various data, e.g., presence information and other media, configuration information, etc., needed for the functioning of the communication device. The memory may further store software or firmware for programming the processing device with the logic or code needed to perform its functionality.

Turning now to the presence server 120, it includes a memory 122, one or more network interfaces 124, and a processing device 126 operatively coupled which provide the means for performing the functionality of the presence server 120, especially the signaling described by reference to FIGS. 2 to 4. The network interface 124 can be wired, wireless, or a combination of both (examples of which are given above) depending on the particular network to which the presence server 120 is connected. The processing device 126 may be programmed with logic or code to perform its functions, wherein the logic is stored as software and/or firmware in the memory 122 (examples of which are given above); and/or the processing device 126 may be implemented as a state machine or ASIC.

Operationally, the presence server 120 receives, in each of a number of publish messages from devices, which can be for instance a SIP/SIMPLE PUBLISH message), a value for a presence information element pertaining to a presentity. Presence information pertaining to a particular presentity includes one or more presence information elements, and a presentity generally sends many publish messages over a period of time for different or the same presence information elements. The presence server 120 maintains (in the memory 122) at least a current value for at least one presence information element for one or more presentities, for distribution to watchers in the network.

The presence server 120 further receives in one or more subscribe messages from a watcher, which can be for instance a SIP/SIMPLE SUBSCRIBE message, a request to be notified regarding presence information for one or more presentities. In response to the subscribe request, the presence server 120 provides to the watcher (for example in one or more SIP/SIMPLE NOTIFY messages) a notification with the presence information that is the subject of the subscription. In addition, the presence server processes subscriptions (e.g., in one embodiment, SIP/SIMPLE SUBSRIBE messages) from one or more watchers in the multicast group for a selectable reliable multicast feature in accordance with the present teachings.

Turning next to the remote network entity 130. The remote network entity, in some embodiments, enables the confirmed mode of multicast delivery in one of more communication devices, in accordance with the present teachings. In this illustrative implementation, the remote network is a CAD system, but may be any other suitable entity with the described confirmed mode of multicast delivery enabling function, such as a remote computer terminal. The CAD system 130 includes a CAD application, typically used by public safety, transportation, and military organizations to assign and dispatch personnel in response to a reported incident, such as an emergency incident. In one illustrative embodiment, the CAD system enables a confirmed mode of multicast delivery for one or more communication devices in multicast group 110.

As the term is used herein, a confirmed mode of multicast delivery means multicast delivery of data to a device that requires the device to send an acknowledgement upon receipt of the data. Contrast that this with an unconfirmed mode of multicast delivery which, as that term is used herein, means multicast delivery of data to a device that does not require the device to send an acknowledgement upon receipt of the data. The CAD system 130 includes (although not shown, wherein examples of the elements are described above) a memory, one or more network interfaces, and a processing device that are operatively coupled, and which form the means for the CAD system 130 to implement its desired functionality, especially the signaling described by reference to FIGS. 2 to 4.

Finally, the media server 140 contains hardware and software needed for sourcing media from one or more media sources, including (although not shown, wherein examples of some elements are described above) a network interface, a processing device, a codec, memory, and the one or more media sources, all operatively coupled, and which form the means for the media server 140 to implement its desired functionality, especially the signaling described by reference to FIGS. 2 to 4. The media server 140 can contain any type of media source (e.g., cameras, files, recorders, etc.) that provides any type of media either real-time or pre-stored, examples of which include, but are not limited to audio, video, still image, text (formatted and non-formatted), file, multimedia, etc.

Definitions for some of the terms used herein will assist in understanding the disclosed teachings. For instance, a presence server is defined as a functional entity that accepts, stores, and distributes presence information or other data associated with presence information. Presence information is defined as a dynamic set of information pertaining to a presentity that indicates status, reachability, willingness, and/or capabilities of a presentity to communicate. Presence information includes, but is not limited to, such status information as, for instance, user availability, location, network availability, user mood, moving direction, speed, destination, estimated time to reach a destination, distance from a destination, incident phase, completed percentage, stage, or phase of an assigned task during an incident, etc. Presence information is comprised of one or more presence information elements, wherein a presence information element is defined as a basic unit of presence information. A presence information element can be associated with a current alpha-numeric value (also referred to herein simply as a value) and/or a set (i.e., one or more) of previous values. A value for a presence information element is defined as a presence related state for that presence information element at a given point in time. For example, a value for a presence information element can define status of a user, such as “away”, “out of office”, and the like. Moreover, a set of current values for a number of presence information elements for a presentity at a particular point in time represents the presence state of the presentity at that particular point in time.

A watcher is defined as a uniquely identifiable logical entity, in a device (either a communication device or an infrastructure device), that is subscribed to certain presence information for one or more presentities and/or that is subscribed (using the presence feature and associated protocols) to reliable multicast delivery of data. The term watcher is used synonymously with the device in which the logical function is housed. A presentity is defined as a logical entity described by presence information. Presentities may represent devices and/or people, and may also represent other types of entities including, but not limited to, servers, buildings, vehicles, applications, or other logical and physical entities. Also a plurality of presentities may be identified by a Presence Resource List (PRL), which is defined as a pre-defined list of presentities (e.g., “Buddy List”) that is traditionally subscribed to in a single operation by a watcher.

A subscription (also referred to herein as a subscribe request) is defined as request from a watcher to a presence server that is generated using a presence service protocol (such as the SIP/SIMPLE protocol) for a subsequent notification of presence information for one or more presentities, or a request for reliable multicast delivery of data upon the enabling of a confirmed mode of multicast delivery. A notification is accordingly defined as the response that the presence server sends to the communication device having presence information for the subscribed to presentities.

Turning now to FIGS. 2 to 4, shown therein are signaling diagrams that illustrate signaling between the communication devices 112, 114, 116, and 118, the presence server 120, the CAD system 130, and the media server 140, for implementing selectable reliable multicast delivery of data in accordance with some embodiments. With respect to the description herein, the functionality illustrated and described by reference to the signaling diagrams of FIGS. 2 to 4 can be performed by means of, for example, a processing device (examples of which are given below) programmed with logic or code to perform its functions, wherein the logic is stored as software and or firmware in a suitable memory device; and/or a processing device implemented as a state machine or ASIC.

Turning first to the signaling diagram 200 shown in FIG. 2; the signaling in this diagram enables the implementation of selectable reliable multicast of presence information from the presence server to a plurality of communication devices in accordance with the teachings herein. The communication devices (watchers) 112, 114, 116, and 118 subscribe to receive presence information regarding one or more presentities, respectively, using subscribe messages 208, 206, 204, 202 sent to the presence server 120. For instance, if the communication devices are used by first responders at an emergency incident, the communication devices may subscribe to receive presence information regarding the location or status of one or more rescue personnel on the scene. In this illustrative embodiment, SIP/SIMPLE SUBSCRIBE messages are used for this purpose, although any other standard protocol message or proprietary message can be used for the presence subscription. Also included in the message exchange (although not shown for clarity of illustration) are corresponding SIP ACK messages from the presence server 120 to the communication devices, and SIP 200 OK messages from the communication devices to the presence server 120.

Upon receiving the subscriptions, the presence server 120 determines to include the communication devices in a common multicast group for more efficient data distribution and communicates a multicast address to the communication devices for joining the multicast group or joins the multicast group on behalf of the communication devices. Known signaling techniques and protocols can be used to join the communication devices to the multicast group such as a SIP JOIN message sequence. It should be noted that additional communication devices and infrastructure devices can be included in the multicast group (to maximize the conservation of communication resources) but only four such devices are shown for ease of illustration.

Upon joining the multicast group 110, a subset (less than all and more than one) of the communication devices, in this case two communication devices 114 and 118, respectively, send subscriptions 212 and 210 to the presence server 120 to subscribe to a reliable multicast delivery information element for ON/OFF change indication of the confirmed mode of multicast delivery. In one illustrative example, a new field is included in the SIP/SIMPLE SUBSCRIBE message to subscribe to reliable multicast delivery. In one embodiment, the confirmed mode of multicast delivery can be enabled (turned ON) or disabled (turned OFF) by the subscribing watcher (for example in the same subscribe message, in some subsequent SIP/SIMPLE message, or in a proprietary message) or by a remote network entity such as a CAD system or another communication device.

In other words, when a communication device subscribes to the reliable multicast delivery of data using a subscribe message, this subscription enables the communication device to receive presence state updates as to whether the confirmed mode of multicast delivery is enabled or disabled for that particular communication device. As stated above, either the watcher or a remote entity can change the presence state of the confirmed mode of multicast delivery for the communication device. This can be done, for instance, through the introduction of a new field (termed herein a presence “dynamic reliability” or “DR” field) for setting the presence state for the reliable multicast delivery presence information element. In one illustrative implementation, the DR field comprises one bit which can indicate whether a confirmed mode of delivery is ON, wherein the communication device will be required to send an ACK (acknowledgement) message upon receipt of the subscribed to data; or the confirmed mode of delivery is OFF, wherein the data is sent using an unconfirmed mode of delivery, and no such ACK message is required upon receipt of the data.

In the case of the watcher setting the DR field, this could be done in the initial SIP/SIMPLE SUBSCRIBE message, wherein a confirmation of the presence state for the reliable multicast delivery information element could be included in a corresponding ACK message from the presence server 120 or in some other message. The presence server 120 also reports to the communication device any changes to the reliable multicast delivery presence information element, which can be sent in a unicast message to the communication device.

As mentioned above, a remote entity can set the DR field and, thereby, change the presence status for the reliable multicast delivery presence information element. In this illustrative implementation, the CAD system 130 sets the DR field. For example, turning back to FIG. 2, the CAD 130 sends a message 214 (any suitable message, either a modified message corresponding to a standard protocol or a proprietary message) to the presence server 120 setting the DR bit ON for the communication device (CD) 114. In this case, the presence server 120 notifies the communication device 114 in a message 216 that the status of the DR bit is ON so that the communication device can set its mode to reliable mode. Message 216 can be, for instance, a SIP/SIMPLY NOTIFY message.

Thus, when the presence server multicasts the notifications 218 (e.g., SIP/SIMPLE NOTIFY messages) with the presence information to the communication devices 112, 114, 116, and 118, the presence information is sent to communication device 114 using the confirmed mode of multicast delivery (wherein the presence server 120 expects an ACK 220) and is sent to the remaining communication devices in the multicast group 110 using an unconfirmed mode of multicast delivery (wherein no such ACK is expected). If the ACK 220 is not received within a time period (T), then the presence server 120 resends a copy 222 of the notification to the communication device 114 (e.g., via unicast or it can be resent via multicast) until it is acknowledged by the communication device 114 or until a maximum number of retries is reached. The time period T can be determined experimentally, for instance, through gained knowledge over time of expected delays in the network.

This selective reliable multicast feature is useful in many scenarios, one of which is a public safety scenario. For instance, watchers associated with important subscribers' roles related to an incident (e.g., commanders, a head of hospital emergency room, a head of the fire shift on duty, etc.) could subscribe to the reliable multicast delivery presence information element and might be included in a multicast group with other watchers to receive presence information for one or more presentities. Since the CAD system has more visibility to the ongoing activities at the incident, the CAD system is responsible, in this scenario, for setting the DR bit ON and OFF for one device or a group of devices depending on the progress of the incident. Accordingly, as the CAD system changes the state of the DR bit, the presence server reports this change in state to the corresponding devices and maintains knowledge in its memory of the DR state of each device subscribed to the reliable multicast delivery presence information element.

In FIG. 2, although two communication devices 114 and 118 subscribed to the reliable multicast delivery information element, the CAD system 130 set the DR bit to ON for only one of those devices (e.g., communication device 114). This might have been set, for instance, for an incident commander in the multicast group 110. However, the CAD system 130 could have, depending on the ongoing circumstances, set the DR bit for both communication devices 114 and 118 or just for communication device 118.

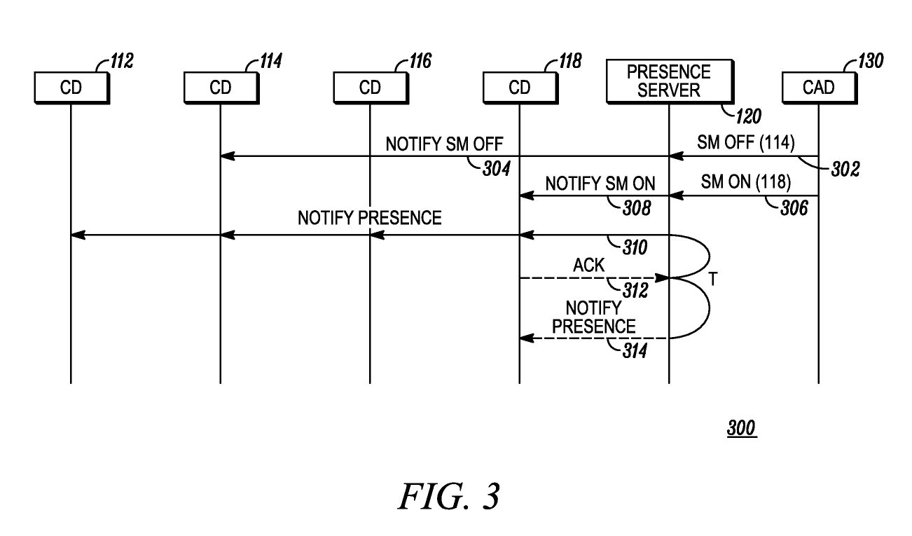

FIG. 3 shows a signaling diagram 300 that illustrates the scenario of where the DR bit is set to the OFF state. For example, suppose the responder using communication device 114 will be leaving the scene soon, and the responder using communication device 118 will be assuming the role of incident commander. FIG. 3 illustrates signaling relevant to this scenario. Accordingly, the CAD system 130 sends a message 302 to the presence server 120 setting the DR bit to OFF for communication device 114, and a message 306 to the presence server 120 setting the DR bit to ON for communication device 118. These messages can each be any suitable message, either a modified message corresponding to a standard protocol or a proprietary message. In turn, the presence server 120 notifies communication device 114 via a message 304 of the change in state for the reliable multicast delivery information element so that the communication device 114 can turn off its reliable mode. Similarly, the presence server 120 notifies communication device 118 via a message 308 of the change in state for the reliable multicast delivery information element so that the communication device 118 can set its mode to reliable mode. Both messages 304 and 308 can be SIP/SIMPLE NOTIFY message.

As a result, when the presence server 120 sends the presence information 310 to the multicast group 110, it no longer expects an ACK from communication device 114. It only expects an ACK 312 from the communication device 118. If the ACK 312 is not received within a time period (T), then the presence server 120 resends a copy 314 of the notification to the communication device 118 (e.g., via unicast or it can be resent via multicast) until it is acknowledged by the communication device 118 or until a maximum number of retries is reached.

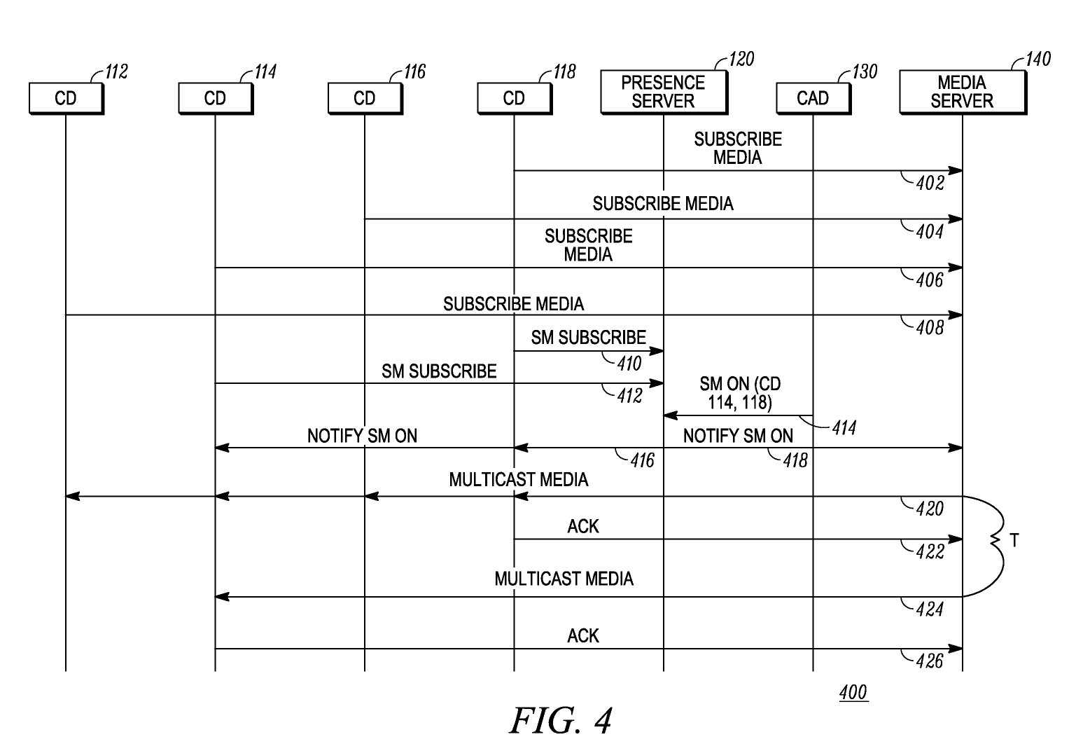

Turning finally to FIG. 4, this diagram comprises a signaling diagram 400 that illustrates an embodiment wherein data other than presence data is sent to the multicast group 110 using the selectable reliable multicast delivery mechanism of the present teachings. In this case, the multicast group has a need for other data besides the presence information data. For example, some images stored at the media server 140 may need to be disseminated to the users in the multicast group 110. Thus, communication devices 112, 114, 116, 118 “subscribe” or send a request to receive the media content from the media server 140 using, respectively, messages 408, 406, 404, and 402. In one illustrative implementation, the communication devices use known signaling techniques, such as SIP signaling, to establish a media session to receive the media content or to join an already existing media session.

In this case, again only communication devices 114 and 118 subscribe to the reliable multicast delivery information element by, respectively, sending messages (e.g., SIP/SIMPLE SUBSCRIBE messages) 412 and 410 to the presence server 120. At some later point, the CAD system 130 sets the DR bit to ON for both communication devices 114 and 118 in a message 414 to the presence server 120, which can be any suitable message, either a modified message corresponding to a standard protocol or a proprietary message. In turn, the presence server 120 notifies communication devices 114 and 118 via a message 416 (e.g., a SIP/SIMPLE NOTIFY message) of the change in state for the reliable multicast delivery information element so that the communication device 114 and 118 can set their modes to reliable mode. The presence server 120 also notifies the media server 140 via a message 418 (which can be any suitable message, either a modified message corresponding to a standard protocol or a proprietary message) to set itself to reliable mode and further notifies the media server 140 that both communication devices 114 and 118 are set to reliable mode so that the media server 140 knows to expect an ACK from both of these communication devices upon receipt of the media.

When the media server multicasts the media 420 to the multicast group 110, it only receives an ACK 422 from the communication device 118 within the time period (T). Therefore, the media server sends a copy 424 of the media (e.g., via unicast or it can be resent via multicast) to the communication device 114, wherein it correspondingly receives an ACK 426 within the time period T.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

I claim:

1. A method for selectable reliable multicast delivery of data, the method comprising:
at a presence server:
receiving, for a subset of a plurality of watchers, a subscription for reliable multicast delivery of data;
wherein the data is sent using a confirmed mode of multicast delivery to watchers in the subset having the confirmed mode of multicast delivery enabled; and
wherein the data is sent to the remaining watchers in the plurality using an unconfirmed mode of multicast delivery.

2. The method of claim 1, wherein the data comprises presence information, the method further comprising:
at the presence server:
receiving, from the plurality of watchers, a subscription to receive notifications for the presence information;
sending the notifications for the presence information using the confirmed mode of multicast delivery to the watchers in the subset having the confirmed mode of multicast delivery enabled; and
sending the notifications for the presence information to the remaining watchers in the plurality using the unconfirmed mode of multicast delivery.

3. The method of claim 1, wherein the confirmed mode of multicast delivery is enabled by a remote network entity for at least a portion of the watchers in the subset.

4. The method of claim 3 further comprising:
notifying the at least a portion of the watchers that the confirmed mode of multicast delivery is enabled, to cause an acknowledgement message to be sent by the at least a portion of the watchers upon receipt of the data.

5. The method of claim 1, wherein the data comprises media that is multicast to the watchers by a media server.

6. The method of claim 5 further comprising the presence server notifying the media server of the watchers in the subset having the confirmed mode of multicast delivery enabled, to cause the media server to switch to reliable mode.

7. The method of claim 1, wherein the confirmed mode of multicast delivery is enabled by setting a dynamic reliability bit.

8. The method of claim 7, wherein the dynamic reliability bit is set by a remote network entity.

9. A system for selectable reliable multicast delivery of data, the system comprising:
a presence server configured for:
receiving, for a plurality of watchers, a subscription to receive notifications for presence information;
receiving, for a subset of the plurality of watchers, a subscription for selectable reliable multicast delivery of presence notifications;
multicasting the notifications for the presence information using a confirmed mode of multicast delivery to watchers in the subset having the confirmed mode of multicast delivery enabled, and notifying the at least a portion of the watchers that the confirmed mode of multicast delivery is enabled, to cause an acknowledgement message to be sent by the at least a portion of the watchers upon receipt of the notifications; and
multicasting the notifications for the presence information to the remaining subscribed watchers in the plurality using an unconfirmed mode of multicast delivery; and
a remote network entity operatively coupled to the presence server and configured for enabling the confirmed mode of multicast delivery in the at least a portion of the watchers.

10. The method of claim 9, wherein the remote network entitiy is a computer aided dispatch system.
